(19) United States
(12) Patent Application Publication
(10) Pub. No.: US 2004/0214133 A1
(43) Pub. Date: Oct. 28, 2004

(54) Auxiliary tool for an articulator

(76) Inventors: Hans Walter Lang, Leutkirch (DE); Alfred Straka, Isny (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/456,889

(22) Filed: Jun. 6, 2003

(30) Foreign Application Priority Data
Jun. 6, 2002 (DE) 102 25 233.5

(51) Int. Cl. A61C 11/00

(52) U.S. Cl. 433/55

(57) ABSTRACT

An auxiliary tool for an articulator having a lower part and an upper part which is connected with the lower part pivotally around a pivot axis extending transversely of the longitudinal plane of the articulator, there extending forwardly from the lower part a lower articulator arm and from the upper part an upper articulator arm, the auxiliary tool including a stand which is mountable on the inner side on the one articulator arm and has a head section on the side of which towards the other articulator arm there are arranged feeler elements for the sensing of certain surface parts on a jaw tooth model which is positioned on the other articulator arm. In order to increase the possibilities for use of the auxiliary tool, the head section has on its side towards the other articulator arm a positioning calotte.

The invention relates to an auxiliary tool in accordance with the preamble of claim 1.

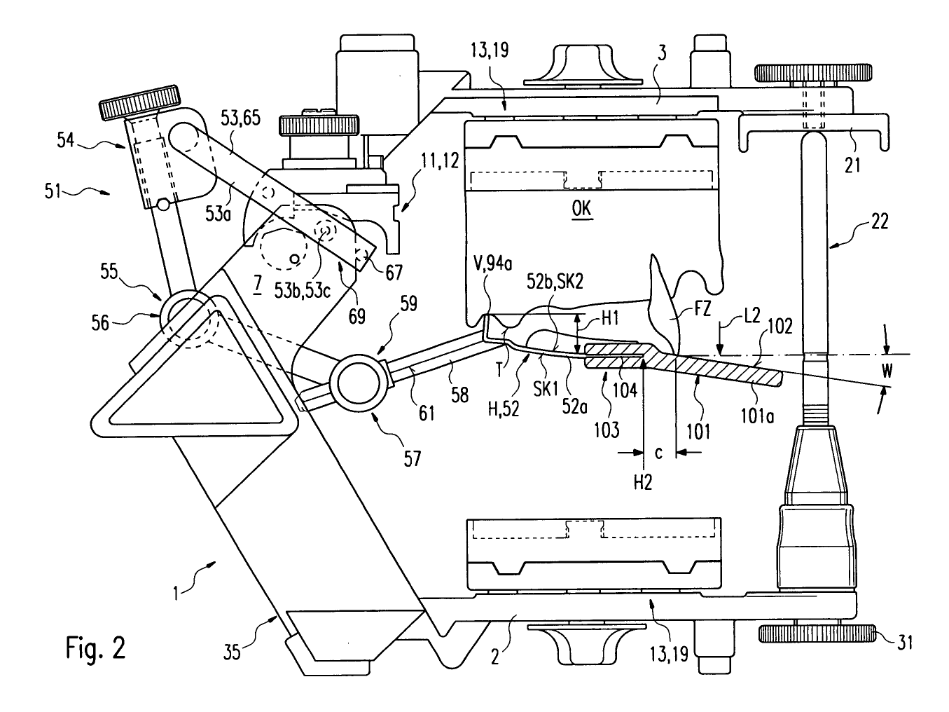

An auxiliary tool of this kind is described in a plurality of configurations in DE 196 21 800 A1, belonging to the present applicant. FIGS. 2 to 7 show an auxiliary tool having a positioning calotte for the positioning of the teeth of at least a lower jaw tooth model, whereby the auxiliary tool is held on the articulator lower part by means of a device having a joint part and a bow. This auxiliary tool constitutes an aid for the positioning of teeth.

FIGS. 9 to 11 of this publication show a mounting device which is mounted on the lower articulator arm of the articulator and makes possible at its upper side feeler elements for supporting an upper jaw tooth model at defined positions. With this mounting device, upper jaw tooth models can be brought into articulation. There are provided two rear and two forward feeler elements of which the rear feeler elements engage into the depressions behind the tuber and the forward feeler elements engage in the fornix which are located between the forward row of teeth and the upper lip extension of the human jaw.

For the auxiliary tools of the kind under consideration there is a requirement to be able to put these to use in as varied a way as possible.

The object of the invention is thus to increase the range of possibilities for use in the case of an auxiliary tool of the kind indicated in the preamble of claim 1.

This object is achieved by means of the features of claim 1.

With the configuration in accordance to the invention according to claim 1, the auxiliary tool has at its side towards the opposing articulator arm a positioning calotte which, with regard to the feeler elements, is located in a position which corresponds to the anatomy of the average human jaw. Through this, the auxiliary tool is suited not only for bringing a tooth model concerned into articulation, but also for the positioning of teeth of the tooth model brought into articulation, or of the opposing tooth model. Through this, both the mechanical effort and also the effort in terms of procedures are substantially reduced and the work simplified and facilitated, because due to the multiple employment of the auxiliary tool the exchange of another auxiliary tool can be omitted. Consequently, work procedures with the auxiliary tool in accordance with the invention allow themselves to be carried out on the one hand more quickly and on the other hand also more precisely, because an exchange with another auxiliary tool, such as is the case with the state of the art, does not arise.

For the positioning of teeth it is sufficient when the positioning calotte has an annular curve shape or a curve shape corresponding to the occlusion surface. It is particularly advantageous when the positioning calotte is formed by means of a plate which is shaped shell-like in this curve shape, whereby there may be arranged on its two broad sides calotte surfaces corresponding to the occlusion surface.

It is further of advantage to configure at least one of the feeler elements to be adjustable between a feeler position and a withdrawn release position. Through this it is possible to move at least one feeler element concerned into its release position, in order to provide space, e.g. for the positioning of teeth.

For part prosthetic and in particular for full prosthetic procedures with an auxiliary tool of the kind concerned here it is of significance to sense such positions of the tooth model concerned which in comparison with the jaw-shape of different persons have positions which are as far as possible the same.

It is further advantageous to so configure an auxiliary tool of the kind concerned that it is suitable for tooth models of different persons. For this purpose the forward feeler element is directed towards the papilla inzisiva or is arranged or adjustable for a support contact or for a feeler contact of the papilla inzisiva. This part of the upper jaw tooth model is a flat jaw component which taking into account the upper jaws of different persons and also of different ages is substantially the same and therefore corresponds to an advantageous average value region. With this auxiliary tool in accordance with the invention different upper jaws can thus be sensed or positioned sufficiently accurately.

Because the upper jaw shape is different from person to person there exists in many cases the requirement to so alter an auxiliary tool that it is individually adaptable to differences of shape.

Thus, the invention has further the object of so configuring an auxiliary tool of the kind indicated in the preamble of claim 9 that it is adaptable to deviations of average shape values of the upper or lower jaw concerned.

This object is achieved by means of the features of claim 9. Advantageous further developments are indicated in the associated subclaims.

With this configuration in accordance with the invention according to claim 9 at least one support or feeler element, in particular a preferably centrally arranged forward feeler element, or two forward feeler elements arranged to the two sides of the longitudinal middle plane, is formed to be height adjustable and positionable in the respectively set height location, so that they retain their set height locations even under loading. The feeler element is preferably formed by means of a screw and of simple and stable structure and reliable function. By these means it is possible, by means of a targeted height adjustment of one or more of the height adjustable feeler elements, to alter their feeler positions in the vertical and thus to adapt the support position of the jaw to different shapes or positions of the upper or lower jaw concerned. For this purpose a step-less adjustment is very suitable in order that this adaptation can be configured individually. This configuration in accordance with the invention makes it possible e.g. by means of a targeted height adjustment of at least one feeler element concerned to alter or adjust the support configuration of the feeler elements in the vertical longitudinal middle plane and/or in the vertical transverse plane running transversely thereto. This configuration in accordance with the invention is particularly advantageous in combination with the solution in accordance with the invention according to claim 5. Here there is needed a height adjustment of only one feeler element, whereby a targeted alteration of the support configuration around a horizontal transverse axis is possible, which with a configuration having feeler elements engaging in the depressions behind the tuber, makes possible a tilting of the support configuration around these feeler elements.

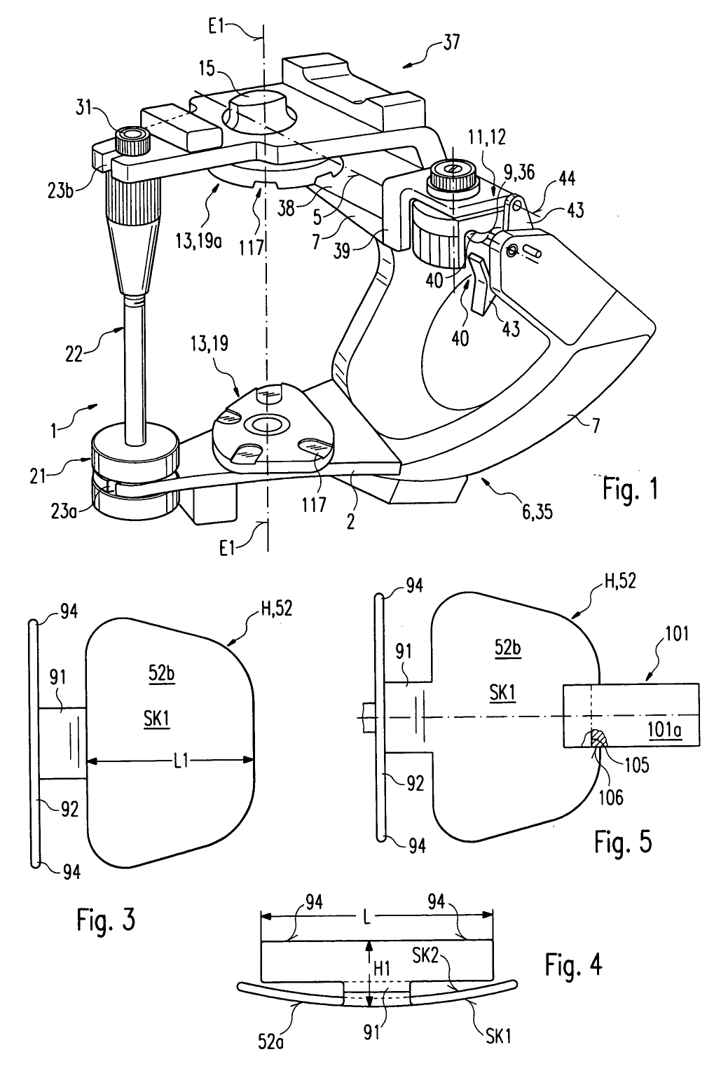

With the known auxiliary tool described in FIGS. 1 to 8 of the above-mentioned publication, this is held by means of a device on the associated articulator lower part, whereby the device has a holder for the auxiliary tool and a bow for the positioning of the holder on the articulator lower part. This known configuration, although it has proven to be useable, is however complex, both with regard to complexity of construction and also the handling effort when working.

The present invention thus further has the object of so simplifying an auxiliary tool of the kind indicated in the preamble of claim 14 that at least the outlay for construction and preferably also the effort for handling is or are reduced.

This object is achieved by means of the features of claim 14. Advantageous developments of the invention are indicated in the associated subclaims.

The configuration in accordance with claim 14 is based on the insight that the support elements, when two rear and lateral feeler elements and one forward or two forward and lateral feeler elements are provided, yield a defined and stable support configuration. Based on this insight, the invention proposes at least two tensioning elements which with the bearing of the feeler elements on the associated feeler surfaces of the upper or lower jaw tooth model concerned ensure that the auxiliary tool is connected with the associated articulator arm or with a component fixedly connected thereto. Through this, a mechanically complex support on the articulator lower part can be omitted. The configuration in accordance with the invention according to claim 14 distinguishes itself through particular simplicity, since it requires only the tensioning elements in order to hold auxiliary tool on the associated tooth model. The tensioning elements are preferably elastic, or they act elastically on the auxiliary tool. Through this, the connection with the associated articulator arm can be further substantially simplified. Preferably, the tensioning elements are formed by means of elastic bands which can be put to use functionally in a certain range of extension and can simply and quickly be brought into connecting position, e.g. by twining around the positioning calotte and the articulator arm itself or mounted components thereof, e.g. particular entwinable counterbearings.

Further features of developments of the invention make possible simple and economically producible configurations, which are of small and economical and long-lived construction, and moreover make possible a ready operation.

Below, the invention and further advantages that can be achieved thereby will be described in more detail with reference to exemplary embodiments and the drawings. There is shown

FIG. 1 an articulator in a perspective side view from the right;

FIG. 2 the articulator with a holder device for holding the auxiliary tool on the articulator, in a side view from the left;

FIG. 3 an auxiliary tool in a view from above;

FIG. 4 the auxiliary tool according to FIG. 3 in a view from behind;

FIG. 5 the auxiliary tool according to FIG. 2 in a view from above;

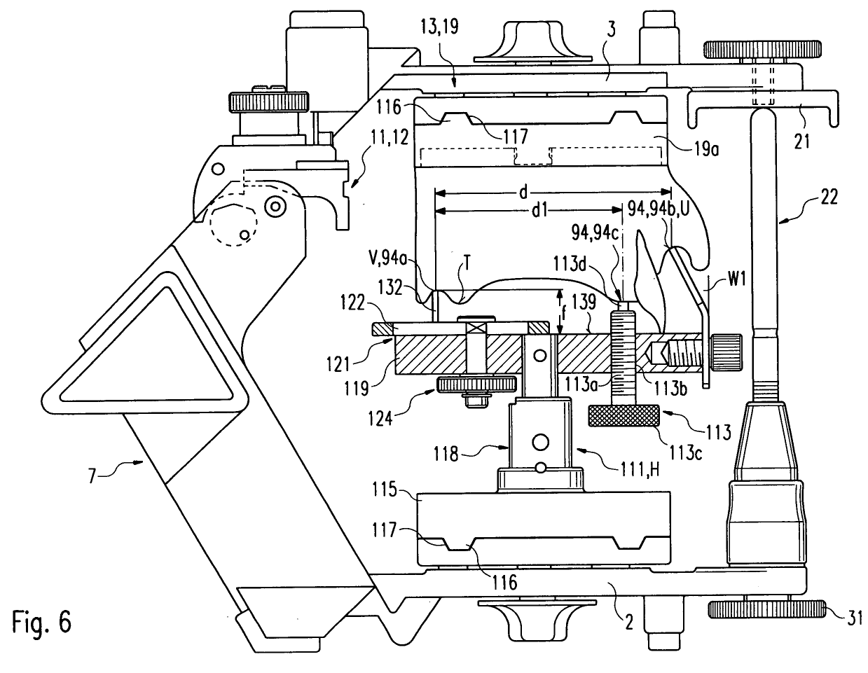

FIG. 6 an articulator with a mounting device in accordance with the invention, in a side view, partially vertically sectioned;

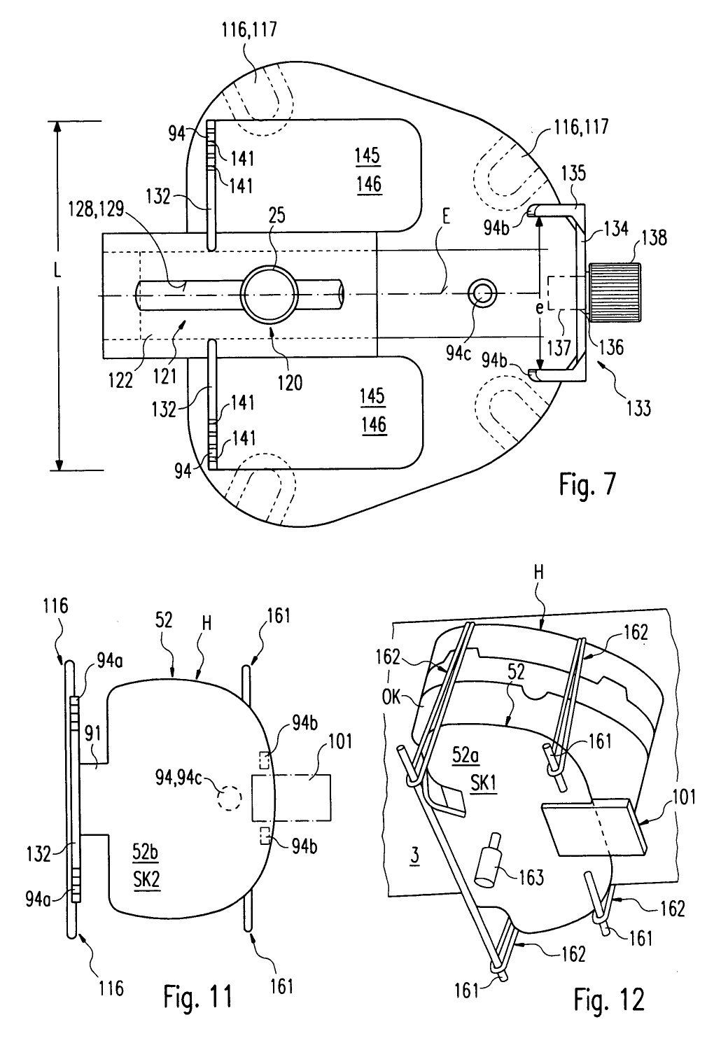

FIG. 7 the mounting device in a view from above;

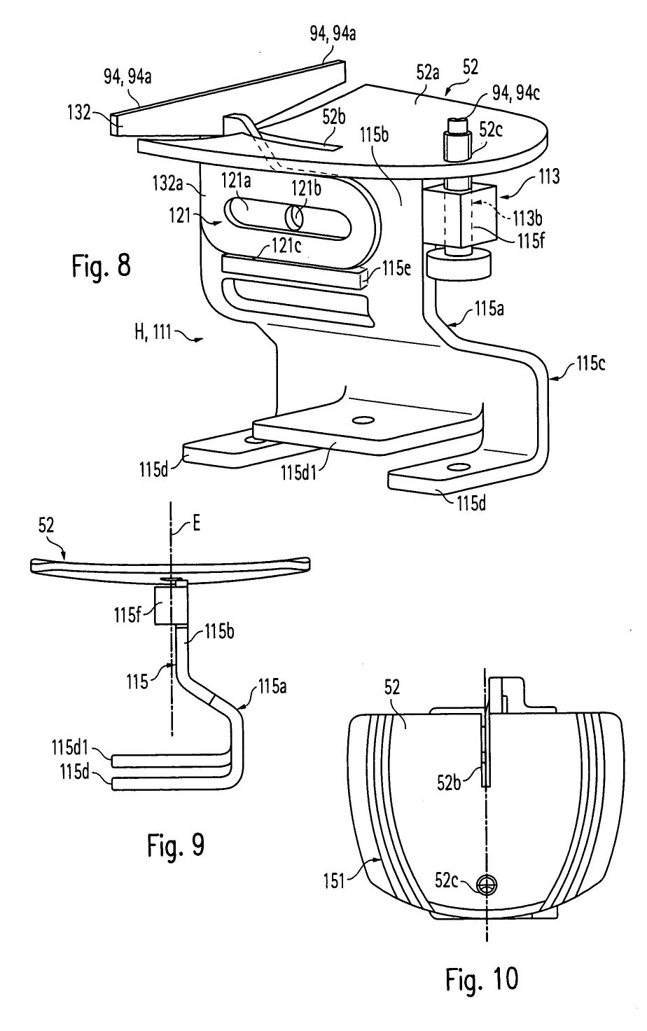

FIG. 8 the mounting device in a modified configuration and in a perspective illustration;

FIG. 9 the mounting device according to FIG. 8 in a view from the front;

FIG. 10 the mounting device according to FIG. 8 in a view from above;

FIG. 11 the auxiliary tool in a modified configuration in a view from above;

FIG. 12 a holding device for holding the auxiliary tool on the articulator, in a perspective side view from below.

The articulator 1 has a lower articulator arm 2 and an upper articulator arm 3, of which the latter is pivotably mounted round a pivot axis 5 extending from the fore rearwardly and at right angles to the longitudinal middle plane El of the articulator 1, on a U-shaped framework or frame 6 having two lateral frame limbs 7 extending upwardly. The pivot bearing parts 9 on the frame side are arranged at the two ends of the frame limbs 7. There is preferably involved a so-called arcon articulator having rotatable or pivotable slide joints 11, of which the slide guide 12 is located on the upper articulator arm 3. In the rearward or middle region of the articulator arms 2, 3 there are arranged, on the sides towards one another, in each case an arrangement area 13 for associated tooth models or tooth model plinth parts, which are each positionable and fixable by means of a screw 15 penetrating the articulator arm 2, 3 in a through-hole and by fitting pins projecting from the articulator arms 2, 3. There are illustrated in the Figures two primary plinths 19 for a lower jaw tooth model and an upper jaw tooth model UK, OK. At the forward end of the one articulator arm 2, 3, here of the lower articulator arm 2, there is attached an incisal table 21 on which there is releasably supported with its free end a telescopic support pin 22 extending upright, which is exactly positioned and attached releasably at the end of the other articulator arm, here the upper articulator arm 3. Preferably the attachment or receiving elements for the incisal table and the support pin 22 are the same or match one another so that the incisal table 21 and the support pin 22 can in each case be attached in mutually opposite positions selectively on the upper or on the lower articulator arm 2, 3. For mounting there serves in each case an fitting slot 23a, 23b preferably extending in the longitudinal middle plane, vertically penetrating the associated articulator arm 2, 3 and opening out at its free end. In these like fitting slots selectively the incisal table 21 or support pin 22 (reversed arrangement) is mountable with a correspondingly matchingly shaped waisting up to mutually corresponding slot ends which form stops limiting the insertion movement, and screwable onto the associated articulator arm 2, 3 by means of a screw part 31.

The articulator 1 consists of a lower part 35 which has the lower articulator arm 2, the frame and the joint heads 36 projecting from the inner sides of the frame limbs 7 coaxially inwardly, and an upper part 37 which has the upper articulator arm 3, a joint boss part 38 and two joint housings 39 laterally attached thereon, in which the joint heads 36 are mounted in each case in a pivot-slide joint 11. The upper part 37 is releasably held on the pivot-slide joints 11 by means of two centric locks 42 associated with joint housings 39. Each centric lock 42 has a C-shaped lock piece 43 which in its closed disposition, pivoted in around the transverse axis 44, engages below, preferably from the rear to the fore, the horizontally inwardly extending joint head 36 and through this secures in the laterally and upwardly opened joint recess 40 which is present.

Starting from the final biting position, lower jaw movements can be simulated in the articulator 1, which corresponds to the anatomical characteristics of the human body. However, with the present exemplary embodiment, the lower jaw or the lower part 35 cannot be moved, but the upper part 37 with the upper jaw can move relative to the lower part 35 (arcon articulator).

The articulator 1 may be a non-adjustable articulator, which is set up in accordance with average values, or may be an adjustable articulator the joint guide surfaces of which are adjustable preferably in many respects and are thus adaptable to the anatomical conditions of the patient head.

The device 51 for holding the auxiliary tool H, here a so-called positioning table or a positioning calotte 52 is of a plurality of main parts, namely a joint part mountable on the articulator lower part 35 in the form of a U-shaped bow 53 with a connection part 54 that can be releasably mounted thereon by means of a plug-in and/or screw connection, and a holder 55 having two joints 56, 57, in particular ball joints, lying behind one another in the longitudinal direction, for the auxiliary tool H, which has a carrier rod 58 projecting approximately horizontally forwardly therefrom which can be inserted into a plug-in fitting 59 of the holder 55, is rotatable therein round its longitudinal middle axis 61, and is longitudinally displaceable and releasably fixable. The bow 53 engages below the lower part 35 or the frame limb 53b with its bow limbs and is mounted pivotably around the pivot axis 5 on the lower part 35 by means of joint parts, e.g. arbors, and counter joint parts 53c arranged on the lower part 35.

The positioning calotte 52 is, in its view from above, adapted to the development or the shape of the row of teeth. Its underside 52a is convexly arched in the sense of the occlusion curve SK1, e.g. with a radius of curvature r of about 125 mm. Through this, the positioning calotte is suited for the formation of tooth cusp inclinations of about 25_{E} to 28_{E}. These are the tooth shapes most commonly to be used, such as Ivoclar, De Try, Lindauer Zähne and the like. Other positioning calottes having other radiuses of curvature which can be employed as needed and required.

The positioning calotte 52 has a connection web 91, extending centrally from its rear side rearwardly, which may be bent off somewhat upwardly, and from the rearward end of which there extends upwardly a transverse web 92 the length L of which is so dimensioned that it extends over the entire width of the upper jaw tooth model OK. The height H1 of the transverse web 92 is so dimensioned that its upper edge is located at the base of the depressions V behind the right and left tubers and the occlusion curve SK1 is located in the correct position with regard to the jaw to be formed, which can be predetermined by means of an average value of the normal bite anatomies. With the present configuration the height H1 of the transverse web 92 from the occlusion curve SK is about 10 to 20 mm, in particular about 15 mm.

The positioning calotte 52 may be of corrosion resistant material such as plastics or metal, in particular metal sheet. It is advantageous to manufacture the positioning calotte 52 in one piece with the connecting web 91 and the transverse web 92. In the case of plastics this can be effected by means of moulding and in the case of metal by means of stamping or drawing or bending. The carrier rod 58 is attached to the rear side of the transverse web 92 or to the underside of the connecting web 91, e.g. by means of welding or soldering. The connecting web 91 may be tapered with regard to the width of the positioning calotte 52 or the length of the transverse web 92.

The transverse web 92 thus forms in its end regions of its upper edge feeler elements 94a for the base of the depressions V, which are located with reference to the occlusion curve SK1 at a height relationship H1 and a spacing relationship A determined in accordance with average values as previously described. In this position, the positioning calotte 52 is located in the articulator 1 by means of the holder 55 and the device 51 for holding.

Thereby it is of advantage to so arrange the device 51 that a removal or lowering or pivoting of the feeler elements 94a out of the depressions V is preferably prevented by stops. As FIG. 2 shows, there may be provided one or two stop pieces 67, e.g. on the bow limbs 53a, which cooperate with the forward side of the associated frame limb 7 as a stop.

The positioning calotte 52 serves with its occlusion curve SK1 as a measurement surface in accordance with which the teeth Z of the lower jaw model UK—not shown for reasons of simplification—centrally positioned on the lower primary plinth 19, can be aligned (positioned) in their height and shaped upon their growth.

If the positioning calotte 52 is of uniformly thick, in particular thin material, e.g. of metal sheet or a uniformly thick plate, the upper side 52b also has an occlusion curve SK2, which can serve for the positioning of upper jaw teeth of an upper jaw model.

The length L1 of the positioning calotte 52 is so dimensioned that it ends at a spacing c from the front teeth FZ of the upper jaw tooth model OK. Thus, the positioning calotte 52 can also be used even in the presence of the front teeth FZ. Otherwise, the latter would impact against the positioning calotte 52 due to the natural over-bite disposition of the front teeth FZ.

For the manufacture of a lower jaw tooth prostheses, in particular a full prosthesis, in accordance with the invention it is proceeded as follows.

In known manner, an impression of the upper jaw of the patient is made. With the aid of a face-bow the tooth model is positioned in a per se known manner on the upper articulator arm in a suitable central disposition, which is effected e.g. by fixing in plaster or through other known measures on the upper primary plinth 19. Then the positioning calotte 52 is positioned by means of the device 51 and the holder 55 in a position in the articulator 1 in which its feeler elements 94a are located on the base of the depressions V and in the region of the front teeth FZ the occlusion curve SK1 or SK2 has a certain height measure H2, which is determined by means of the correct front tooth height or front tooth length L2 taking into account a normal over-bite size. The front tooth length L2 is determined from the patient by means of phonetic trials, if appropriate also taking into account aesthetic considerations. Through this the new teeth make possible a pronunciation, e.g. of the letter F, without problems, which letter is pronounced with the front teeth FZ bearing on the lower lip.

Due to the bearing of the feeler elements 94a, the position of the positioning calotte 52 is determined in the vertical transverse plane, whereby the feeler elements 94a are located in the correct approximately horizontal transverse axis or height disposition. The form-locking engagement of the feeler elements 94a in the depressions V makes possible also a certain positioning of the auxiliary tool H, or of the positioning calotte 52, in the approximately horizontal plane. Through the front tooth length L2, to be determined, the position of the positioning calotte 52 is also determined in the third direction and thus completely.

In contrast to known procedures, with which the indications necessary for producing the tooth prosthesis are derived from the lower jaw, with the invention these are derived from the upper jaw or from the upper jaw tooth model OK, which is advantageous for the reasons already described in the introduction, since the anatomical structures on the upper jaw change only slightly even with increasing age of the patient, and in any event less than on the lower jaw.

With the configuration of the auxiliary tool H according to FIGS. 2 and 5, in which the same or similar parts are provided with the same reference signs, there is associated with the positioning calotte 52 a forward part 101 having an upper measurement surface 102 which, taking into consideration a desired over-bite size, is located in a position at which the front teeth FZ of the upper jaw OK end. Consequently, also the front teeth FZ of the upper jaw can be dimensioned or positioned in accordance with the measurement indications of the measurement surface 102. Or it is also possible to sense with the auxiliary tool H the front tooth length L2 previously determined in accordance with other methods, e.g. phonetically, of the previously formed or only dimensioned front teeth F2. Thereby, the front tooth length L2 can serve in connection with one of the known methods for the determination of the inclination of the occlusion curve SK1 or SK2 concerned, e.g. parallel to the Campers plane, or together with the sensing of the depression V behind the tuber T to serve as indication for the determination of the position of the auxiliary tool H in the articulator 1. The measurement surface 102 may develop horizontally or also forwardly inclined, e.g. by an angle W from about 0 to 10_{E}, in particular about 5_{E}.

It is of advantage to provide for the connection of the forward part 101 with the positioning calotte 52 a quick-fastening connection, in particular a plug-in connection 103, which makes possible a ready connection and release of the forward part 101. With the present configuration, the plug-in connection 103 is formed by means of a slot 104 adapted to the shape and size of the wall of the positioning calotte 52 with slight play for movement, with which the forward part 101 can be plugged onto the wall in approximately central position, preferably with a slight clamping tension, so that in the plugged-on position the forward part is releasably fixed. Since the wall of the positioning calotte 52 is arched in the lateral direction there is needed also a positioning of the forward part 101 in the lateral direction. For this purpose there serves a centering device which in the case of the present example is formed by means of a forward recess 105 in the positioning calotte 52, the width of which corresponds to the width of the forward part 101 with play for movement, so that in the plugged-on position of the forward part 101 its rod-shaped forwardly projecting body 101a is laterally centered between the side surfaces 106 of the recesses 105. The stop present in each case for the plug-on movement ensures a certain position of the forward part 101 in the longitudinal direction, which in particular with an inclined measurement surface 102 is of significance, since in the absence of an appropriate positioning in the longitudinal direction measurement errors could arise due to the inclined measurement surface 102. In the transverse direction the measurement surface 102 extends straight.

The forward part 101 may likewise be of metal or plastics.

It is advantageous within the scope of the invention, to take into account different over-bite sizes, to provide a plurality of forward parts 101, the measurement surfaces 102 of which provide different over-bite sizes in determined steps. By these means it is possible, taking into account a desired over-bite size, to mount and use the appropriate forward part 101.

The invention also comprehends a method and a mounting device which make it possible to position (articulate on) an upper jaw tooth model OK in the articulator without a face-bow. Such a mounting device 111 is illustrated in various configurations in FIGS. 5 to 10, whereby the same or similar parts are provided with the same reference signs. The main parts of the mounting device 111 are a stand which is fixable on the articulator lower part 35 in a certain position and in its head region has 3 or 4 support or feeler elements 94 for the sensing of the upper jaw tooth model OK at certain positions, of which the two rearward feeler elements 94a may be provided for the sensing of the depressions V. In the forward region of the auxiliary tool H or of the positioning calotte 52 there may be provided a central feeler element 94b or two feeler elements 94b, to the two sides of the longitudinal middle plane and thus arranged at a transverse spacing from one another, for sensing the so-called fornix U of the human jaw, or a feeler element 94c arranged in the longitudinal middle plane E of the articulator 1 for sensing the papilla inzisiva of the upper jaw tooth model. The papilla inzisiva is a small gum position behind the front tooth row which is well suited as a parameter, because the differences of the positions of the papilla inzisiva from the person to person are slight and the gum position papilla inzisiva changes only slightly even taking into account normal growth alterations. The fornix U is located between the tooth row and the upper lip extension of the human teeth, whereby it extends arc-like corresponding to the horizontal contour of the upper jaw. The feeler element 94c forms with the feeler elements 94a the apex of the Bonwill's triangle. It is preferably fixable located horizontally, longitudinally of the vertical middle plane E.

The feeler elements 94 may thereby be located in a height position in the articulator 1 which is predetermined by means of average values of the human teeth.

The feeler element or elements 94b or 94c arranged in the forward region may be height adjustable, in order either to make possible an adaptation to the individual shape of the upper jaw tooth model OK or in order to be able to position the upper jaw tooth model OK in different positions tilted up or tilted down around rearward feeler elements, here the feeler elements 94a, through which different inclinations of the occlusion plane can be realized.

In the case of the exemplary embodiment the feeler element 94c is height adjustable by means of a setting device 113, in particular a screw device. Preferably the feeler element 94c is a screw 113a which is screwed into a threaded hole 113b extending approximately vertically in the stand 112 in a position which, taking into account average values with regard to the other feeler elements 94a, 94b, corresponds to the position of the papilla inzisiva. The screw 113a is preferably a hand-screw having a manually rotatable screw head 113c at the lower end. The upper end of the screw preferably has a tapered pin 113d, in order to be better able to sense the papilla inzisiva.

With the feeler elements 94, the position of the upper jaw tooth model OK can be determined in the articulator 1. Through this the upper jaw tooth model OK shaped after the impression of the upper jaw is placed on the feeler elements 94 and fixed on the upper articulator arm 3 in this stable position, and this by means of known measures, e.g. fixing by plaster.

Thereafter, with use of the auxiliary tool H the preparation of the tooth prosthesis can be effected in the region of the lower jaw in the above-described manner.

With the present configuration, the mounting device 111—which likewise constitutes an auxiliary tool H—has on the underside of the stand foot 115 a centering device with a plurality of convergent centering webs 116 which engage into matching centering recesses 117 at the upper side of the lower articulator arm 2, here on the associated primary plinth 19. There is preferably arranged therebetween a quick-fastening connection, in particular a per se likewise known magnetic coupling (not illustrated), which ensures a ready and rapid release and replacement of the mounting device 111, e.g. to examine or treat the lower jaw tooth model UK temporarily at another location. Other centering devices are also useable.

A corresponding mirror-image configuration can also be provided for the releasable holding of a corresponding secondary plinth 19a on the upper primary plinth 19.

Upwardly from the stand foot 115 there extends a column 118 at the upper end of which there is attached a plate-like head piece 119 preferably extending in the longitudinal direction. The head piece 119 forms in the region of its rearward longitudinal half a longitudinal guide 121 for a slider 122 on which the feeler elements 94a are located. With the present configuration, the longitudinal guide 121 is formed by means of a guide bolt 124 having a head 125 which is placed in a vertical hole 126 of the head piece 119, preferably penetrating completely therethrough, and having lateral plane guide surfaces 127, which constitute longitudinal guide 121, on which the slider 122 with the side surfaces 128 of a longitudinal slot 129 is guided. The slider 122 is fixable in its respective displaced position by means of a fixing device which in the case of the present configuration is formed by means of a hand-nut which is screwed onto the lower thread end of the guide bolt 124 projecting beyond the head piece.

The feeler elements 94a are formed by means of the upper edges of two transverse webs 132, arranged edgewise, which are attached to the two sides of the longitudinal guide 121 on the slider 122 and extend from the latter sideways. There may also be provided a through-going transverse web. The length L measured over the transverse web 132 corresponds to the length of the transverse web 92 of the above-described exemplary embodiment.

The feeler elements 94b are formed by means of the head ends of a fork piece 133 having a fork web 134 and fork limbs 135, which is releasably attached in the forward end region of the head piece 119 by means of an attachment device. With the present configuration, the fork piece 133 is releasably attached to the forward end surface of the head piece 119 by means of a hand-screw 138 screwed into a threaded hole 137 in the head piece 119 and penetrating the fork web 134 in a round hole 136. This configuration also makes possible a lateral pivoting away, e.g. downwardly, of the fork piece 133, after the release of the hand-screw 138, when it is not required.

The longitudinal guide 121 makes possible a setting of the horizontal spacing d or dl between the feeler elements 94a and 94b or 94c and thus of the feeler elements 94a, whereby the feeler elements 94b, 94c are not adjustable in the longitudinal direction and thus define a fixed point. Thus, with the present configuration the adaptation of the spacing d, dl to the size of the teeth present is effected by means of an adjustment of the feeler elements 94a. The transverse spacing e of the feeler elements 94b from one another is about 20 mm.

With the present configuration, the fork limbs 135 are rearwardly inclined by an acute angle W1, which is about 15 to 20_{E}.

It is also possible, instead of two lateral feeler elements 94b, to provide only one centrally arranged feeler element 94b for the sensing of the fornix U in the middle region of the teeth, which may be arranged on a middle upright limb of a carrier (not illustrated) attached to the head piece 119.

It is advantageous to form the upper side of the head piece 119 in the region behind the feeler element or elements 94b or between the feeler elements 94b, 94c from measurement surface 139 for the front teeth FZ of the upper jaw tooth model OK. In this case, this measurement surface 139 is arranged at a certain vertical spacing f between it and the feeler elements 94. Thereby, this measurement surface 139 may be horizontally arranged.

The individual parts of the mounting device 111 may be of metal, in particular light metal, or plastics.

There may be arranged on the upper edge of the feeler elements 94a or of the transverse webs 132 in each case a plurality of markings or notches 141 spaced from one another in the transverse direction, which in comparison with the upper jaw structure make possible a lateral aligning of the upper jaw tooth model OK.

The mounting device 111 may have to the two sides of its longitudinal middle plane approximately horizontal upwardly facing bearing surfaces 145 for a wax wall of the upper jaw tooth model OK, which in each case are preferably located in the region of the rearward two thirds of the mounting device. With the present configuration, the bearing surfaces 145 are formed by means of the upper sides of two plates 146 which are fixed to the slider 122 and preferably project sideways from it.

With the exemplary embodiment in accordance with FIGS. 8 to 10, for which the same or similar part are provided with the same reference signs, although the auxiliary tool H or the mounting device 111 is likewise formed in the shape of a table, the plate-like head piece of the table is however formed by means of the positioning calotte 52 which at least at its upper side 52b has a positioning surface which corresponds to the associated occlusion surface, whereby the calotte body, arched downwardly in a ring shape or shell shape corresponding to the occlusion surface, is supported by means of a stand foot 115 on the articulator lower part 35 or on the lower articulator arm 2. For this purpose, depending upon the configuration of the associated articulator there may serve the primary plinth 19 and/or the arrangement station 13.

In the case of the exemplary embodiment the stand foot, here designated by 115a, has an upper vertical wall 115b extending longitudinally with respect to the longitudinal middle plane E, from which wall section there extends downwardly a foot section 115c, initially laterally away then in a hook shape again laterally back, the foot end 115d of which is located horizontally and approximately centrally with regard to the wall section 115a or the longitudinal middle plane E and on the underside has a stand surface. In order to be able to position one and the same mounting device 111 on different articulators having differently high arrangement stations 113, the foot section 115c has in its lower free end region a middle tongue-shape foot limb 115dl, divided of by means of gaps to both sides, extending transversely of the wall section 115a, which with its lower stand surface is arranged higher than the other two foot ends 115d. For fixing the stand foot 115a on the articulator there may be provided holes 115e, e.g. for fixing screws and/or a magnetic device, in particular if the stand foot 115a is of ferrous metal.

As already in the case of the exemplary embodiment according to FIGS. 6 and 7, in the case of the exemplary embodiment according to FIGS. 8 to 10, the feeler elements 94a are also adjustable by means of the setting device designated by 120 in the longitudinal guide 121 and fixable in the respective adjusted position. Here also, the feeler elements 94a may be arranged on a transverse web 132, from which a carrier web 132a extends downwardly and forwardly, which is held and guided and in the guide 121 displaceably on the wall section 115b. The guide 121 may here be formed by means of a longitudinal hole 121a extending horizontally in the carrier web 132a, through which there extends a horizontal clamping screw, in a hole 121b in the wall section 115b, which penetrates through, and with which the wall section 115b and the carrier web 132a can be clamped against one another. In the rearward region of the calotte body 52a there may be arranged a slot 52b in which the upper region of the carrier web 132a is longitudinal displaceable. The guide 121 is preferably so constituted that the feeler elements 94a are located at the same height in any displacement position. In the case of the exemplary embodiment this is ensured by means of a guide surface 121c which stands out laterally from wall section 115b and bears on the carrier web 132a with a horizontally extending guide edge which in the case of the exemplary embodiment is formed by means of the horizontal under edge of the carrier web 132a. The guide edge 132c is preferably formed by means of a tongue 115e cut out in a U-shaped and pressed out from the stand foot 115b, through which it is formed in one piece. The latter makes possible also the above-described configuration of the stand foot 115b, as a punching or bent part or as injection moulded part.

In the case of the exemplary embodiment, the threaded bore 113b is formed in a bush 115f which is fixed in the wall section 115b. The latter has preferably a forward edge which is set back in the sense of a recess, whereby the bush 115f is attached on the wall section 115b in the region of the preferably rearwardly set back forward edge. Through this there is provided a forward free space below the forward region of the positioning calotte 52 which makes possible a ready access to the adjustable, here rotatable, feeler element 94c and this by means of a manual turning of the screw head, if applicable with a tool. For the through engagement of the screw, through the positioning calotte body 52a, there is provided in this a through-hole 52c. Within the scope of the invention it is also possible to form this through-hole as a threaded hole in which the screw is vertically adjustable.

The auxiliary tool H formed by means of the mounting device 111 makes possible three functions, namely an articulating on, a positioning of the teeth of the upper jaw model OK (prosthesis) and a production of an upper jaw wax wall.

The positioning calotte 52 preferably has on its upper side at least one marking 151 emphasizing the tooth row, which marking is arranged to the two sides of the longitudinal middle plane E and is located in the region of an average tooth row of the human teeth. Through this there can be effected by means of optical comparison of the tooth row of the upper jaw tooth model OK with the marking 151 an alignment and/or checking in a simple manner. In the case of the exemplary embodiment, the marking is formed by means of a line corresponding to the arc-like tooth row, which may be formed by means of the line-like colouring or grooving, or an elevation of the surface 52a of the positioning calotte 52. Preferably a plurality of markings 151 are arranged next to one another, which even in the presence of tooth rows of different sizes make possible a simple optical comparison.

In the case of the presence of a wax wall, the upper jaw tooth model OK can be positioned by means of placing in the articulator also without employment of the feeler elements 94a and if applicable with the employment of the feeler elements 94b or 94c.

The auxiliary tool H in accordance with FIGS. 8, 9 and 10 is conceived for the positioning of the teeth of an upper jaw model OK or prosthesis. Here, work takes place from above against the concavely curved positioning surface 52b.

The exemplary embodiment in accordance with FIGS. 11 and 12, for which the same or similar parts are likewise provided with the same reference signs, is an alternative to the configuration according to FIG. 2. In the case of this configuration the auxiliary tool H, constituting a positioning aid, has the positioning calotte 52 with mutually oppositely arranged counterbearings 161, which preferably stand out laterally, but which may also stand out towards the convex side. In the case of the exemplary embodiment, the counterbearings 161 are formed by means of at least two or more pins arranged opposite to one another and standing out, which may be arranged e.g. in the lateral forward and rearward corner regions of the positioning calotte 52. It is the purpose of the counterbearings 161 to form counterbearings for connection bands 162 with which the positioning calotte 52 can be held, preferably can be elastically tensioned, on the associated jaw tooth model, e.g. OK. The connecting bands 162 may be e.g. elastic rubber bands, which at their one end are fixed to the associated articulator part, here the upper carrier arm 3, and at the other end twine round a counterbearing 161. For the connection of the one end of the connecting bands 162, counterbearings may likewise be arranged on the articulator, which are twined around by the associated connection band 162. Also there can be provided in each case for two oppositely lying counterbearings 161 a common connection band 162, which twines around a part of the articulator 1 such that its free ends can be connected with mutually oppositely lying counterbearings 161. By these means it is also possible that such a common connection band twines around the associated complete articulator part, here e.g. the upper articulator arm 3. In the case of such a configuration variant, the twining round of the articulator part is visible, which could be seen as a disadvantage. Further, such connection bands would not be held on the articulator part in a manner such that they are incapable of being lost. If, however, such common connecting bands 162 twine around a part mounted on the articulator part, e.g. an associated plinth 19 or 19a, in an associated gap between the plinth and the articulator part, then such common connection bands can also be held on the articulator part in a manner that they are incapable of being lost, which naturally is advantageous. The jaw tooth model OK or UK concerned is articulated on the associated articulator or articulator arm 3, 2.

This alternative configuration is based on the insight that it is sufficient for a useable solution to hold the positioning calotte 52 on the associated jaw model by means of the connection bands 162, whereby the positioning calotte 52 supports itself on the tooth model with the feeler elements 94 present. Here, there is needed a bearing on the tooth model in at least three points or support locations distributed in a triangle shape, at which the positioning calotte 52 has on its side towards the jaw tooth model in each case a feeler element 94, 101. In the case of the exemplary embodiment there are arranged two lateral feeler elements in the rearward region of the positioning calotte 52 and one or two feeler elements in the forward region of the positioning calotte 52. In the case of the rearward feeler elements there are preferably involved such feeler elements 94a which engage into the depressions V behind the tubers T. In the case of the feeler element or elements arranged in the forwarded region there may be involved a central feeler element 94b, or two lateral feeler elements 94b, for engagement in the fornix, or a feeler element 94c for support on the papilla or a forward part 101, which supports itself with its feeler surface on at least one front tooth, as has been described above. This auxiliary tool H serves for the positioning of the teeth of lower jaw models OK or prostheses. Work takes place from below against the convex positioning surface 52a.

With this configuration, no holder 55 having two joints 56, 57 arranged behind one another is needed, but only the connection bands 162 and counterbearings 161, in order to hold the positioning calotte 52 stably on the associated jaw tooth model. The carrier rod 58 is not necessary. Then, the desired or all teeth of a tooth model, here a lower jaw tooth model UK (prostheses) held on the lower articulator arm 2, lying opposite to the convexly arched positioning surface SK1, can be positioned against the positioning surface 52a, whereby the positioning surface of the positioning calotte 52 predetermines the associated length measure for the tips of the teeth.

The auxiliary tool H can be arranged in a position rotated by 180_{E} at or on the lower articulator arm 2 and held in the above-described manner with the connecting bands 162. Then, the teeth of an upper jaw tooth model OK can be positioned against the positioning surface 52.

In the case of the exemplary embodiment according to FIGS. 11 and 12 the positioning table formed by means of the positioning calotte 52 is supported on the e.g. toothless model OK or UK only via its defined fixing points, here the feeler elements 94. This positioning aid H is so constituted that the aligning and fixing can be realized solely via the respective model, here the OK model, and not via further components.

In order to be able to handle the positioning calotte readily, there may be arranged on the side of the positioning calotte 52 away from the associated tooth model, here on its underside, a hand grip 163, e.g. in the shape of a pin, preferably having a thickened head, which is fixable or releasably connected with the positioning calotte, e.g. is screwed on into a threaded hole.

1. (Cancelled).

2. Auxiliary tool according to claim 19,
wherein,
the head section is formed by means of a plate, shaped correspondingly to the positioning calotte.

3. Auxiliary tool according to claim 19,
wherein,
the stand has an upper wall section extending in or parallel to the longitudinal plane, from which there extends downwardly in an angled shape a foot section.

4. Auxiliary tool according to claim 3,
wherein,
the foot section extends initially towards one side and then towards the other side so far that its free end region forms a horizontal foot limb arranged approximately centrally with respect to the wall section.

5. Auxiliary tool according to claim 19,
wherein,
a forward feeler element has an arrangement matching to a papilla inzisiva of an upper jaw tooth model positionable between the auxiliary tool and the upper articulator arm.

6. Auxiliary tool according to claim 5,
wherein,
the forward feeler element is height adjustable.

7. Auxiliary tool according to claim 6,
wherein,
the height adjustable feeler element is height adjustable by means of rotation of a screw part.

8. Auxiliary tool according to claim 6,
wherein,
the height adjustable feeler element is provided by means of a screw.

9. (Cancelled).

10. Auxiliary tool according to claim 20,
wherein,
the height adjustable feeler element penetrates the head section or the plate in a through-hole or in a threaded hole.

11. Auxiliary tool according to claim 20,
wherein,
there is arranged a rearward region of the auxiliary tool, on one or on both sides with reference to the longitudinal plane, an upwardly extending feeler element for the sensing of the depression behind a respective tuber of the upper jaw tooth model.

12. Auxiliary tool according to claim 11,
wherein,
the feeler element or feeler elements is or are adjustable approximately horizontally and parallel to the longitudinal middle plane.

13. Auxiliary tool according to claim 12, [characterized in that] wherein, the feeler element or feeler elements [(94a)] is or are adjustable in a guide [(121), preferably the feeler elements [(94a)] being connected with one another by means of a transverse web [(32)] and being adjustable in a common guide (121)].

14. (Cancelled).

15. Auxiliary tool according to claim 21,
wherein,
the tensioning elements are elastically variable in length.

16. Auxiliary tool according to claim 15,
wherein,
the tensioning elements are formed by means of elastic bands.

17. Auxiliary tool according to claim 21,
wherein,
a side of the positioning calotte towards the one articulator arm is shaped convexly in the sense of an occlusion curve .

18. Auxiliary tool according to claim 21
wherein,
the positioning calotte has in its forward region a measuring surface for front teeth of the upper jaw model, which touches or limits the tips of the front teeth.

19. Auxiliary tool for an articulator,
said articulator defining a longitudinal plane and comprising
an upper part,
a lower part, said upper part being pivotally connected to the lower part about a pivot axis extending transversely with respect to the longitudinal plane of the articulator,
a lower articulator arm extending forwardly from the lower part, and
an upper articulator arm extending forwardly from the upper part, one of said articulator arms defining an inner side,
said auxiliary tool comprising
a stand mountable on said inner side of one said articulator arm, said stand comprising a head section having a side directed toward the other said articulator arm,
feeler elements disposed on said side of said stand for sensing surface parts of a jaw tooth model positionable on the other said articulator arm, and,
a positioning calotte disposed on said side of said stand.

20. Auxiliary tool for an articulator,
said articulator defining a longitudinal plane and comprising
an upper part,
a lower part, said upper part being pivotally connected to the lower part about a pivot axis extending transversely with respect to the longitudinal plane of the articulator,
a lower articulator arm extending forwardly from the lower part, and
an upper articulator arm extending forwardly from the upper part, one of said articulator arms defining an inner side,
said auxiliary tool comprising
a stand mountable on said inner side of one said articulator arm, said stand comprising a head section having a side directed toward the other said articulator arm, and
feeler elements disposed on said side of said stand for sensing surface parts of a jaw tooth model positionable on the other said articulator arm, wherein at least one said feeler element is height adjustable by means of a screw.

21. Auxiliary tool for an articulator,
said articulator defining a longitudinal plane and comprising
an upper part,
a lower part, said upper part being pivotally connected to the lower part about a pivot axis extending transversely with respect to the longitudinal plane of the articulator,
a lower articulator arm extending forwardly from the lower part, and
an upper articulator arm extending forwardly from the upper part,
said auxiliary tool comprising a positioning calotte on one side thereof toward the upper articulator arm,
feeler elements for sensing surface parts of an upper jaw tooth model positionable on one said articulator arm, and,
at least two counterbearings disposed on opposite sides of said auxiliary tool, at least two tensioning elements supported from one said articulator arm on the upper jaw tooth model mounted thereon, each said tensioning element engaging an associated counterbearing to position the auxiliary tool with said feeler element bearing on the upper jaw tooth model.

22. Auxiliary tool of claim 2, wherein said plate carries at least one of said feeler elements.

23. Auxiliary tool according to claim 13, wherein said feeler elements are connected with each other by means of a transverse web and are adjustable in a common guide.

24. Auxiliary tool according to claim 16, wherein the tensioning elements comprise rubber bands.

25. Auxiliary tool according to claim 17, wherein the occlusion curve corresponds to Spee's curve.

26. Auxiliary tool according to claim 18, wherein the measuring surface is disposed on an auxiliary tool part which is connectable with the positioning calotte by means of a quick-fastening connection.

27. Auxiliary tool of claim 26, wherein said quick-fastening connection is a plug-in connection.
